(19) United States
(12) Patent Application Publication
(10) Pub. No.: US 2014/0258537 A1
(43) Pub. Date: Sep. 11, 2014

(54) Storage Management of a Storage System

(71) Applicant: CORAID, INC., Redwood City, CA (US)

(72) Inventors: Stephen Ira Schleimer, Campbell, CA (US); Nakul Pratap Saraiya, Palo Alto, CA (US); Alok Rishi, Millbrae, CA (US); Lawrence McGoff Matter, Millbrae, CA (US); Nicholas Asher Sterling, Cedar Park, TX (US); Miroslav Klivansky, Oakland, CA (US); Robert James Przykucki, JR., Redwood City, CA (US)

(73) Assignee: Coraid, Inc., Redwood City, CA (US)

(21) Appl. No.: 13/794,266

(22) Filed: Mar. 11, 2013

(51) Int. Cl. H04L 29/08

(52) U.S. Cl. CPC H04L 67/1097
USPC 709/226

(57) ABSTRACT

A method for storage management in a storage system, such as a storage area network (SAN). A selection of a first target level of storage service quality (e.g., bronze, silver, gold, platinum) for a storage repository to be created in the SAN is received. The first target level of storage service quality represents a level of storage service quality for the storage repository along a first dimension (e.g. performance, availability) of storage service quality. A first set of storage configuration properties associated with the first level of desired storage service quality is determined. One or more storage components of the SAN are allocated to the storage repository based on at least one storage configuration property in the first set of storage configuration properties.

### BACKGROUND

1. Field of the Disclosure

This disclosure pertains in general to storage systems and in particular to managing storage in a storage system, such as a storage area network (SAN).

2. Description of the Related Art

Modern storage systems may support many different application servers that share access to the resources of the storage system. Each application server can have different storage requirements. For example, e-mail servers require high availability, whereas video encoding servers require high performance. Additionally, modern storage systems can include many different types of storage devices, such as magnetic disk drives, solid state drives, tape drives, and optical drives that are distributed across a network. Due to the large number of devices available in the storage system, it can be difficult for a person managing the storage system to know what storage resources are available and to properly match the requirements of the application servers to the resources available in the storage system.

### SUMMARY

Embodiments of the present disclosure are related to a storage management tool for managing storage of a storage system, such as a SAN. The storage management tool constrains the properties that can be used to allocate a storage repository based on a target level of storage service quality. Different levels of storage service quality result in different properties being used in creating a storage repository, which helps guide a user towards generating a storage repository that meets the user's desired requirement.

In one embodiment, a computer-implemented method for storage management in a storage area network (SAN) comprises receiving a selection of a first target level of storage service quality (e.g., bronze, silver, gold, platinum) for a storage repository to be created in the SAN. The first target level of storage service quality represents a level of storage service quality for the storage repository along a first dimension (e.g. performance, availability) of storage service quality. A first set of storage configuration properties associated with the first target level of storage service quality is determined. One or more storage components of the SAN are allocated to the storage repository based on at least one storage configuration property in the first set of storage configuration properties.

In one embodiment, the levels of desired service quality can be specified along multiple dimensions. The method thus further comprises receiving a selection of a second target level of storage service quality for the storage repository. The second target level of storage service quality represents a level of storage service quality for the storage repository along a second dimension of storage service quality that is different than the first dimension of storage service quality. A second set of storage configuration properties associated with the second target level of storage service quality is determined. One or more storage components of the SAN are allocated to the storage repository based on at least one storage configuration property from the first set of storage configuration properties and at least one storage configuration property from the second set of storage configuration properties.

### BRIEF DESCRIPTION OF THE DRAWINGS

The teachings of the embodiments disclosed herein can be readily understood by considering the following detailed description in conjunction with the accompanying drawings.

FIG. 1 is a high-level block diagram of a computing environment for storage management of a storage system according to one embodiment.

FIG. 2 is a detailed view of a storage management module 140 according to one embodiment.

FIG. 3 is a user interface for starting profile creation according to one embodiment.

FIG. 4 is a user interface for profile creation according to one embodiment.

FIG. 5 is a user interface for profile creation according to another embodiment.

FIG. 6 is a user interface that includes a list of storage profiles according to one embodiment.

FIG. 7 is a user interface for starting generation of a repository creation plan according to one embodiment.

FIG. 8 is a user interface for generating a repository creation plan according to one embodiment.

FIG. 9 illustrates a user interface that includes a repository creation plan created by the planning module according to one embodiment.

FIG. 10 is flowchart illustrating a process of storage management for a storage system performed by the management module, according to one embodiment.

FIG. 11 illustrates the hardware architecture of a management server according to one embodiment.

### DETAILED DESCRIPTION

The Figures (FIG.) and the following description relate to various embodiments by way of illustration only. It should be noted that from the following discussion, alternative embodiments of the structures and methods disclosed herein will be readily recognized as viable alternatives that may be employed without departing from the principles discussed herein.

Reference will now be made in detail to several embodiments, examples of which are illustrated in the accompanying figures. It is noted that wherever practicable similar or like reference numbers may be used in the figures and may indicate similar or like functionality. The figures depict various embodiments for purposes of illustration only. One skilled in the art will readily recognize from the following description that alternative embodiments of the structures and methods illustrated herein may be employed without departing from the principles described herein.

Embodiments disclosed herein describe a tool for storage management of a storage system, such as a storage area network (SAN). Different configurations of storage components are abstracted to higher levels of storage service quality such that many configurations of storage components can satisfy the abstract levels. The levels of storage service quality are presented to a user managing the storage system. As the user selects a storage service level, storage configuration properties for the selected storage service level are determined and may be presented to guide the user in creating a storage repository that satisfies the user's desired storage requirements.

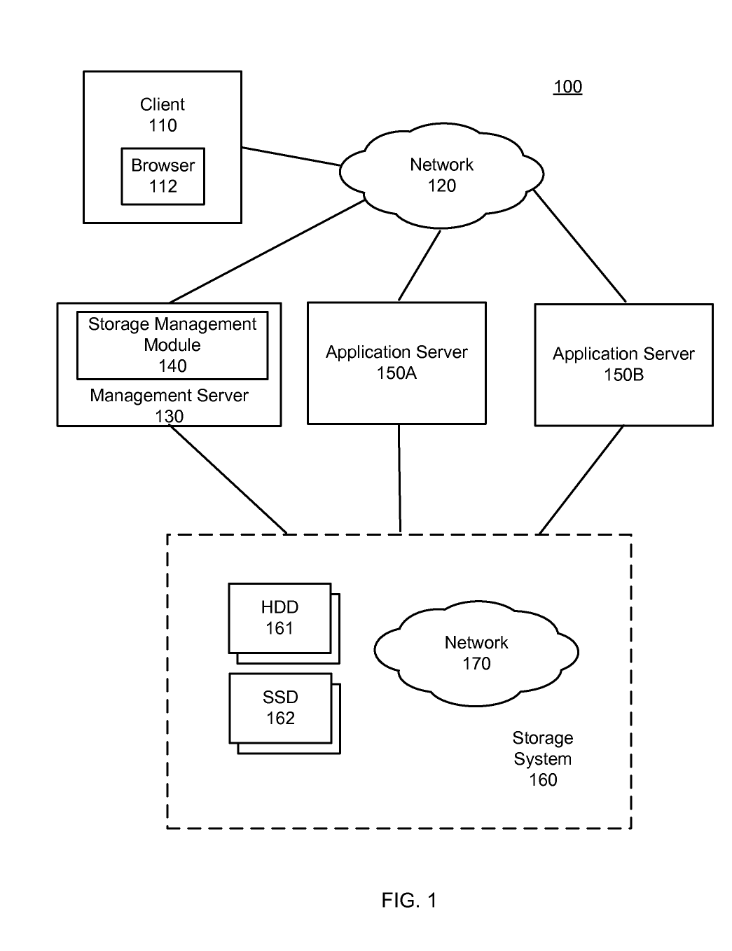

FIG. 1 is a high-level block diagram illustrating a computing environment 100 for storage management of a storage system 160 according to one embodiment. The computing environment 100 includes a client 110, a management server 130, and several application servers 150 connected to a network 120. In one embodiment, the computing environment 100 may exist within a datacenter. Only one client 110 and two servers 130 are shown in FIG. 1 to simplify and clarify the description. Other embodiments of the computing environment 100 can have a different number of clients 110 and/or application servers 150.

In one embodiment, the management servers 130 and application severs 150 are server class computers. The management server 130 and application servers 150 communicate with the storage system 160 via network 170. The management server 130 manages the configuration of storage repositories within the storage system 160. The application servers 150 store data within the storage repositories of the storage system 160. The application servers 150 may implement different applications that have differing storage requirements. For example, application server 150A may be an e-mail server that requires high levels of availability but does not need fast performance, whereas application server 150B may be a video encoding server that requires fast performance but does not need high levels of availability.

The storage system 160 includes several storage components for persistent storage of data, such as hard disk drives (HDD) 161, solid state drives (SSD) 162, tape drives (not shown) and optical drives (not shown). The storage components can be organized into storage repositories, which are collections of one or more physical storage components that are grouped together to provide storage services. For example, a storage repository can be two HDDs 161 in a RAID1 configuration to provide redundancy in the event of a drive failure. As another example, a storage repository can be a single SSD 162 that provides no data redundancy but has fast performance. The quality of service provided by a storage repository thus varies depending on the storage components of the repository. Repositories may have an initial size when first created, and more storage units can be added to the repository as required. Repositories can also be sub-divided into smaller portions, each of which is assigned a different logical unit numbers (LUN) that is accessed by the application servers 150

The storage system 160 may also include a network 170 through which the management server 130 and application servers 150 communicate with the storage components. Network 170 may include communication links using technologies such as Ethernet, Fibre Channels, or the like. In one embodiment, the storage system 160 is a storage area network (SAN). The SAN can be a dedicated network that provides access to consolidated, block level data storage within the SAN. The SAN can be located in one physical location or can span multiple physical locations. The application servers 150 can communicate with the SAN via the network 170 using a communication protocol such as ATA over Ethernet (AoE), Fiber Channel Protocol (FCP), Fiber Channel over Ethernet (FCoE), or other appropriate communication protocol.

The management server 130 includes a storage management module 140 that manages the storage components in the storage system 160. The management module 140 interacts with the client 110 to provide storage management information for display at the client 110 and to receive selections from the storage management information. In one embodiment, the management server 130 receives selections of desired or target levels of storage service quality (e.g., bronze, silver, gold, platinum) for different dimensions of storage service quality. Upon receiving a target level of storage service quality, the storage management module 140 automatically determines storage configuration properties for creating a storage repository that are associated with the target level of storage service quality. In other words, the storage configuration properties are represented in abstract form by the levels of storage service quality. The storage management module 140 thus simplifies the process of creating a storage repository by constraining the possible storage configuration properties to those are appropriate only for the selected target level of storage service quality. The storage configuration properties can then be used in allocating storage components to a storage repository.

In one embodiment, a client 110 is a computer used by one or more users to manage the storage repositories within the storage system 160. In other embodiments, the client 110 is a network-capable device other than a computer, such as a personal digital assistant (PDA), a smartphone, etc. The client 110 executes a web browser 112, such as MICROSOFT INTERNET EXPLORER, that allows the user to retrieve and display storage management information from the management server 130. The user makes configuration selections through the browser 112 that are transmitted to the management server 130 and used to manage the storage system 160. In one embodiment, client 110 may receive storage management information from the management server 130 in the form of HTML files, via the Simple Network Management Protocol (SNMP), via representational state transfer (REST), or other appropriate application programming interface (API). In other embodiments, client 110 may include standalone software running on a computer that receives management information and provides selection of management information to the management server 130 with or without displaying any information to a user.

The network 120 represents the communication pathways between the client 110, management server 130, and application server 150. Although client 110, management server 130, and application server 150 are all connected to the same network 120, client 110 and management server 130 may not necessarily have access to the application servers 150. In one embodiment, the network 120 can be an internal network or the Internet. In one embodiment, the network 120 uses standard communications technologies and/or protocols. Thus, the network 120 can include links using technologies such as Ethernet, 802.11, integrated services digital network (ISDN), digital subscriber line (DSL), asynchronous transfer mode (ATM), etc. Similarly, the networking protocols used on the network 120 can include the transmission control protocol/Internet protocol (TCP/IP), the hypertext transport protocol (HTTP), the simple mail transfer protocol (SMTP), the file transfer protocol (FTP), etc. The data exchanged over the network 120 can be represented using technologies and/or formats including the hypertext markup language (HTML), the extensible markup language (XML), etc. In addition, all or some of the links can be encrypted using conventional encryption technologies such as the secure sockets layer (SSL), Secure HTTP and/or virtual private networks (VPNs). In another embodiment, the entities can use custom and/or dedicated data communications technologies instead of, or in addition to, the ones described above.

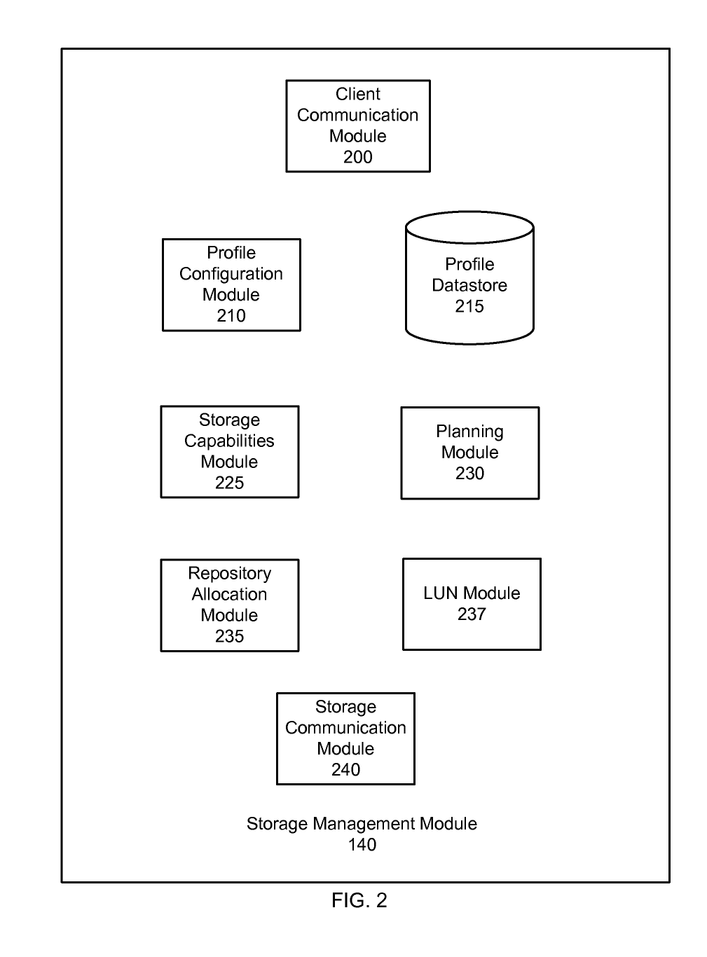

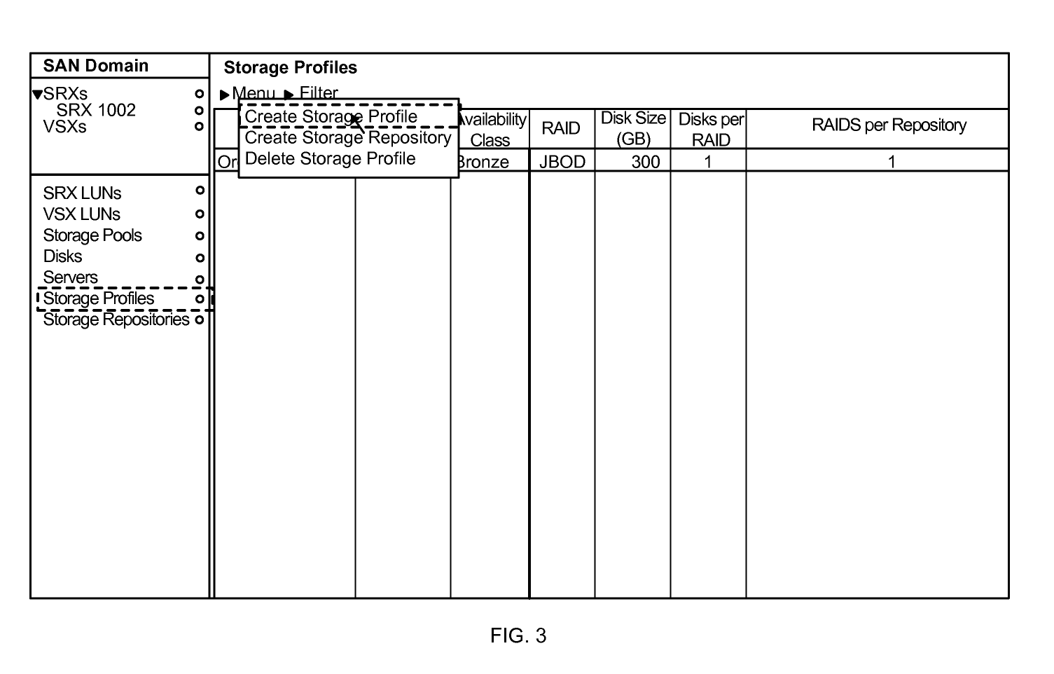

FIG. 2 is a detailed view of a storage management module 140 according to one embodiment. The management module 140 includes a client communication module 200, a profile configuration module 210, a profile database 215, a storage capabilities module 225, a planning module 230, a repository allocation module 235, a LUN module 237, and a storage communication module 240. Some of the modules will be described by reference to the user interfaces of FIG. 3-9.

The client communication module 200 handles communications between the other modules of the management module 140 and the client 110. The client communication module 200 transmits storage management information to the client 110 that can be displayed at the client 110 to guide a user through the process of configuring the storage system 160. In other embodiments, the storage management information may not be displayed at the client 110. The client communication module 200 also receives different types of user selections from the client 110 that are used in configuring the storage system 160. In one embodiment, the client communication module 200 communicates with the client 110 through an API.

The profile configuration module 210 interacts with the client 100 via the client communication module 200 to generate a storage profile. A storage profile is a collection of storage configuration properties in association with a profile name. The storage configuration properties establish guidelines that are to be followed when allocating storage components to a storage repository. In other words, the storage configuration properties form a recipe that can be used to create a storage repository that meets the user's desired level of service quality.

Specifically, the profile configuration module 210 generates a user interface that allows the user to select a storage class representing a desired or target amount of storage service quality by selecting from different levels of storage service quality. The user interface is provided to the client 110 via the client communication module 200 and displayed at the client 110. The profile configuration module 210 provides, to the client 110, one or more sets of storage configuration properties associated with the selected levels of service quality for display in the user interface. The user can select one or more of the storage configuration properties and the profile configuration module 210 generates a storage profile from the selected storage configuration properties.

Referring to FIG. 3, illustrated is a user interface for starting profile creation according to one embodiment. In the user interface of FIG. 3, the profile configuration module 210 presents an option of creating a new storage profile. The user clicks on “create storage profile” and the profile configuration module 210 receives this selection to start the profile creation process.

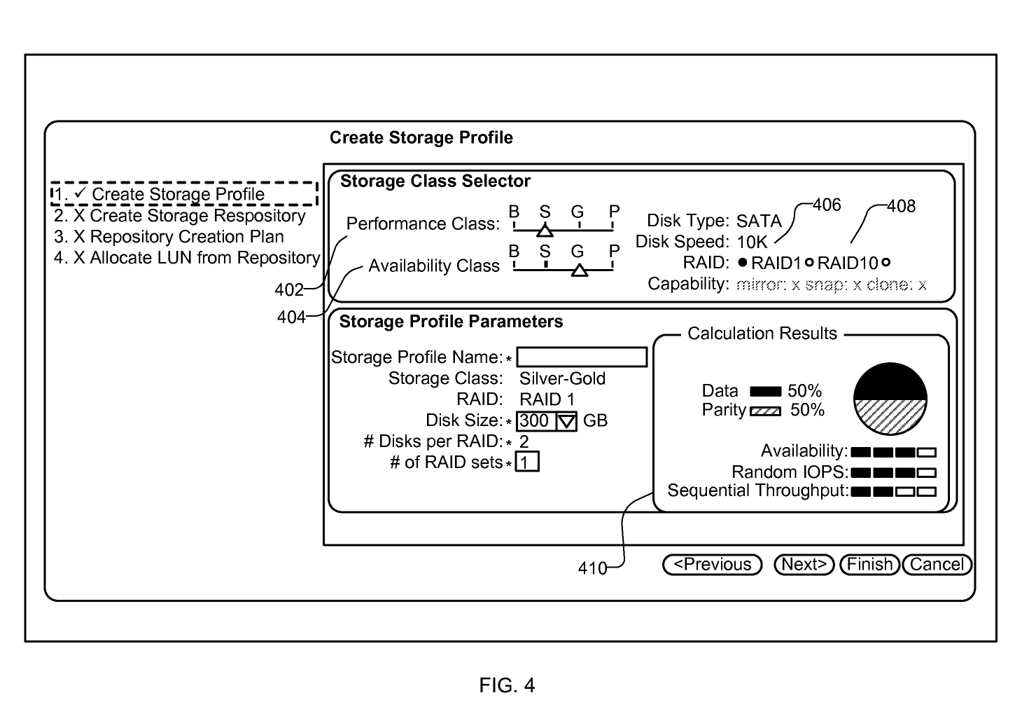

FIG. 4 is a user interface for profile creation according to one embodiment. In the user interface of FIG. 4, there are two sliding scales 402 and 404 that include different levels of storage service quality. The user can select one or more levels of storage service quality from the sliding scales 204 and 404 to select a storage class representing an overall desired quality of service to be provided by a storage repository.

The storage service quality of a storage repository can be measured in several dimensions, such as dimensions of (1) performance (2) availability or (3) affinity. Each dimension represents a different type of storage service quality. Performance, availability and affinity are only examples of dimensions of storage service quality, and in other embodiments other dimensions are possible.

Performance may refer to the rate at which data can be transferred to and from the storage system. Performance is affected by both the latency and the bandwidth of the storage components. Storage repositories using components with higher bandwidth and lower latency will have higher performance than storage repositories using storage components with low bandwidth and high latency. Sliding scale 402 represents the performance dimension.

Availability may refer to the degree of failure a storage repository can withstand while still providing service. Availability is affected by the use of parity bits or redundant storage. Storage repositories that have greater data redundancy will have higher availability than storage repositories that have little or no data redundancy because they can withstand hardware failures without being taken offline. Sliding scale 404 represents the availability dimension.

Affinity may refer to the level of resource sharing of different LUNs that are allocate from a single storage repository. For example, low affinity means that the LUNs assigned to a repository should share as few physical resources as possible (different disk drives, different drive controllers, different network interfaces, etc). Thus, if low affinity is desired, it may be preferable to have a storage repository that uses many storage drives spread across different controllers and network interfaces. A slider for affinity is not shown in FIG. 4.

Each sliding scale 402 and 404 includes multiple levels of storage service quality for the user to choose from. The levels are shown here with the symbols B for bronze, S for silver, G for Gold and P for platinum. B is the lowest level of storage service quality and P is the highest level of storage service quality. In other embodiments, the storage service levels may be indicated by a number (e.g., 1, 2, 3, 4) or some other visual indication of storage service quality. The storage service levels may also be presented in other ways, such as in a drop down menu or in list of storage service levels instead of in a sliding scale.

The user selects target levels of storage service quality by interacting with the sliding scales 402 and 404 and the profile configuration module 210 receives the user's selection. Once the profile configuration module 210 receives the user's selection of a target service level, it determines a set of storage configuration properties that are recommended for the user's target storage service levels, i.e. storage configuration properties that will result in the allocation of a storage repository meeting the user's target storage service levels. A storage configuration property describes a hardware configuration of storage components that are to be added to a storage repository. There may be many possible storage configuration properties, some of which are appropriate for the target storage service level, and others which are not appropriate for the target storage service level. The profile configuration module limits or constrains the storage configuration properties to only a few properties that make sense for the target storage service level.

In one embodiment, the profile configuration module 210 maintains a mapping between each of the possible storage service levels and their recommended storage configuration properties. Each of the storage service levels may be associated with a different set of recommended storage configuration properties that is appropriate for the selected storage service level. The mappings may also be pre-determined and stored in a look up table.

For example, a mapping between performance levels and storage configuration properties is as follows:

| Performance Level | Storage Configuration Properties |
|---|---|
| Bronze | 5.4K revolutions per minute (RPM) HDD, |
| | 7.2K RPM HDD |
| Silver | 10K RPM HDD |
| Gold | 15K RPM HDD, Hybrid HDD with SSD cache |
| Platinum | SSD |

Lower performance levels, such as Bronze, are mapped to HDD that have a low RPM and therefore low performance. Higher performance levels, such as Silver, are mapped to HDD that have a higher RPM and therefore higher performance. The highest performance level, Platinum, is mapped to SSDs which have the highest amount of performance.

As another example, one mapping between availability levels and storage configuration properties is as follows:

| Availability Level | Storage Configuration Properties |
|---|---|
| Bronze | Just a Bunch of Discs (JBOD), RAID0 |
| Silver | RAID5 |
| Gold | RAID1, RAID10 |
| Platinum | RAID1, RAID10, RAID6 with remote mirror |

Lower availability levels, such as Bronze, are mapped to non-redundant drive configurations of JBOD and RAID0 that have no data protection in the event of a hardware failure. Higher availability levels, such as Platinum, are mapped to RAID1, RAID10 and RAID6 drive configurations which have a high amount of data protection in the event of a hardware failure.

The profile configuration module 210 then provides the set of storage configuration properties mapped to the target storage service level(s) to the client 110 for display at the client 110. In other embodiments, the set of storage configuration properties may be provided to the client 110 but not displayed. The set of storage configuration properties can include one or more storage configuration properties. The storage properties serve as recommendations to guide the user in configuring a storage repository that meets the target storage service levels. Referring still to FIG. 4, the user has selected a performance level (storage class) of Silver. In response, the profile configuration module 210 presents a single disk speed option 406 of “10K” in the user interface. All the other disk speeds are hidden from view because the other disk speeds are not recommended for the target performance level. In other embodiments there may be multiple disk speeds presented to the user instead of just a single disk speed. The user has also selected an availability level of gold. In response, the profile configuration module 210 presents two RAID configuration properties 408 in the user interface: RAID 1 or RAID 10.

The profile configuration module 210 also provides additional information to the client 110 for display in the user interface to help the user understand the storage profile that is being created. Referring still to FIG. 4, the user interface includes quality metrics 410 of the storage repository that will be allocated according to the configuration properties shown in the user interface. The metrics 410 show that half of the storage repository will be reserved for parity information to implement RAID1. The metrics 410 also indicate that availability of the storage repository will be fairly high, and that the performance will be about average.

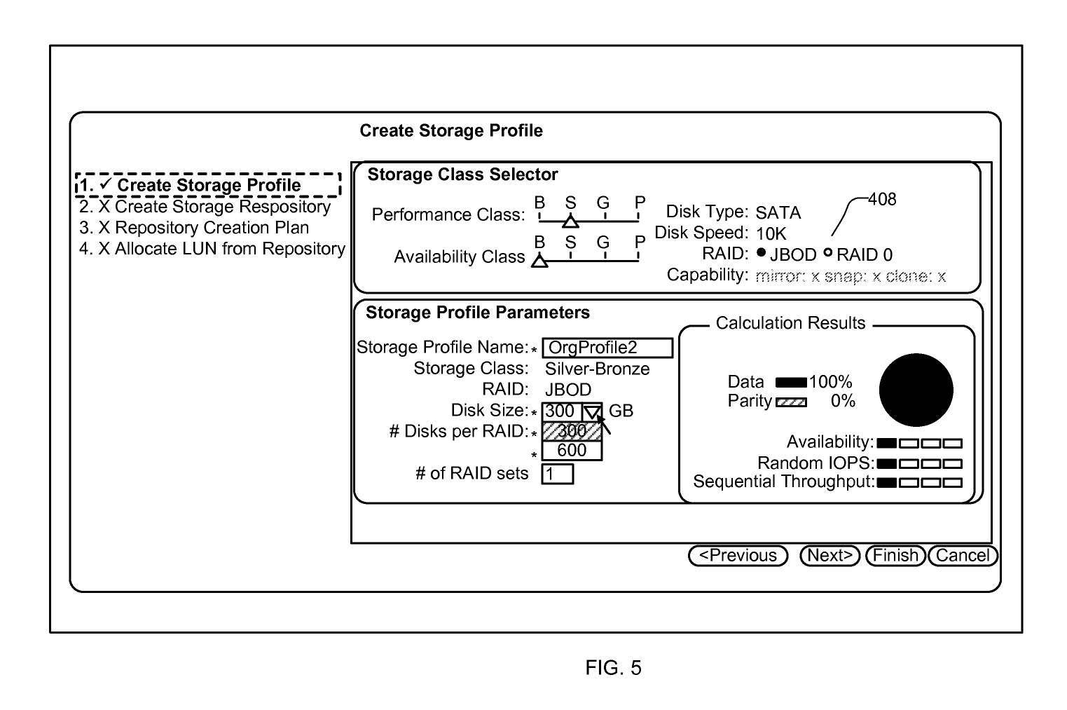

FIG. 5 is a user interface for profile creation according to another embodiment. The user has now selected an availability level of Bronze. In response, the profile configuration module 210 provides RAID configuration properties 408 of JBOD and RAID0 for display in the user interface. Because the user has decreased the target level of availability from Gold to Bronze, the RAID options presented to the user also represent storage configurations that have a decreased level of availability.

If more than one storage configuration property is available for a given dimension of service quality, the user can select a subset of the storage configuration properties (i.e. less than all the properties) presented in the user interface. The profile configuration module 210 receives the user's selection and uses the selected subset of properties in generating a storage profile that is stored in the profile datastore 215. Here, the user has selected the RAID property of “JBOD” instead of “RAID0”. The user has also entered “OrgProfile2” as the name of the profile. The profile configuration module 210 receives this information and generates a storage profile that includes the profile name of “OrgProfile2” in association with the selected RAID property of JBOD. Alternatively, if only one storage configuration property for a given dimension of storage service quality is available for selection, the user can simply approve of the property and the profile configuration module 210 receives this approval as a selection of the displayed storage configuration property.

Referring back to FIG. 2, the profile datastore 215 stores storage profiles that are created by the profile configuration module 210. Each storage profile can include a unique name of the storage profile in association with storage configuration properties selected by the user. There may be multiple storage profiles stored in the profile datastore 215. Once created, the configuration profiles can be re-used to allocate many different storage repositories, which reduces time spent by the user in managing the storage system 160.

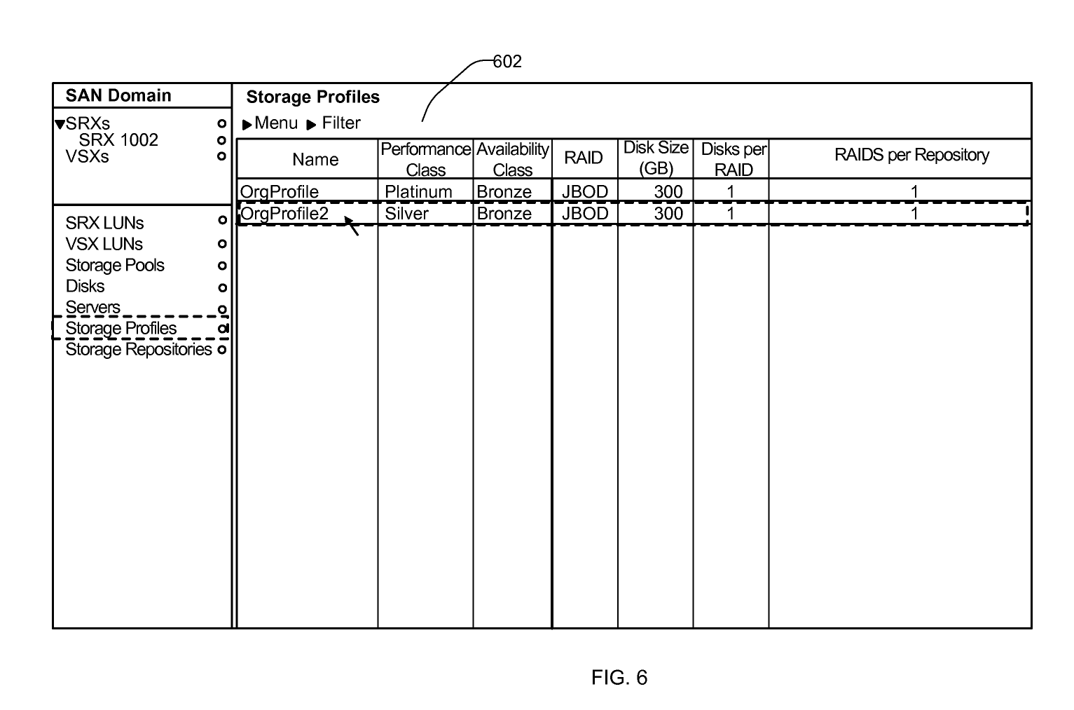

The storage profiles can also be provided to the client 110 for display in a user interface. For example, referring to FIG. 6, illustrated is a user interface that includes a list of storage profiles, according to one embodiment. The user interface includes a profile section 602 indicating that two storage profiles have been created in the database. One storage profile is named OrgProfile and another storage profile is named OrgProfile2. OrgProfile has a performance level of Platinum and an availability level of Bronze. OrgProfile2 has a performance level of Silver and an availability level of Bronze.

Referring back to FIG. 2, the storage capabilities module 225 determines the current storage capabilities of the storage system 160. Storage capabilities may include any information about the configuration of the storage system 160 and its ability to handle data, such as the number, type, and capacity of storage components (e.g., HDD 161 or SSD 162) that are in the storage system 160. Storage capabilities may also include whether the storage components are currently allocated to a storage repository, and also whether the storage components have suffered any past failures. In one embodiment, the storage capabilities module 225 may communicate with the storage system 160 via the storage communication module 240 to obtain information about the storage capabilities of the storage system 160.

Planning module 230 receives a selection of a storage profile and compares the storage profile to the current capabilities of the storage system 160 to determine whether the selected storage profile can be used to allocate a storage repository. If the current storage capabilities of the storage system 160 can support the storage profile, the planning module 230 generates a repository creation plan for a storage repository. On user request, the plan is presented in a user interface for verification. If the current storage capabilities of the storage system 160 indicate that the storage profile is not supported by the current storage capabilities, a repository creation plan is not generated and instead an error is presented to the user. For example, if a storage profile requires 300 GB hard drives and only 200 GB hard drives are available, a storage repository cannot be allocated because the storage system 160 lacks the correct resources.

In one embodiment, the planning module 230 identifies specific physical storage components that match the storage configuration properties. The planning module 230 then generates a repository creation plan that includes an identification of the specific physical storage components that will be allocated to a storage repository. The repository creation plan can also include other information, such as a unique name for the storage repository. Additionally, the repository creation plan can include the relationship among storage components needed to create the repository. For example, if a pool is required as part of the repository, then the LUNs which will be placed in the pool are listed and the inclusion operations are listed.

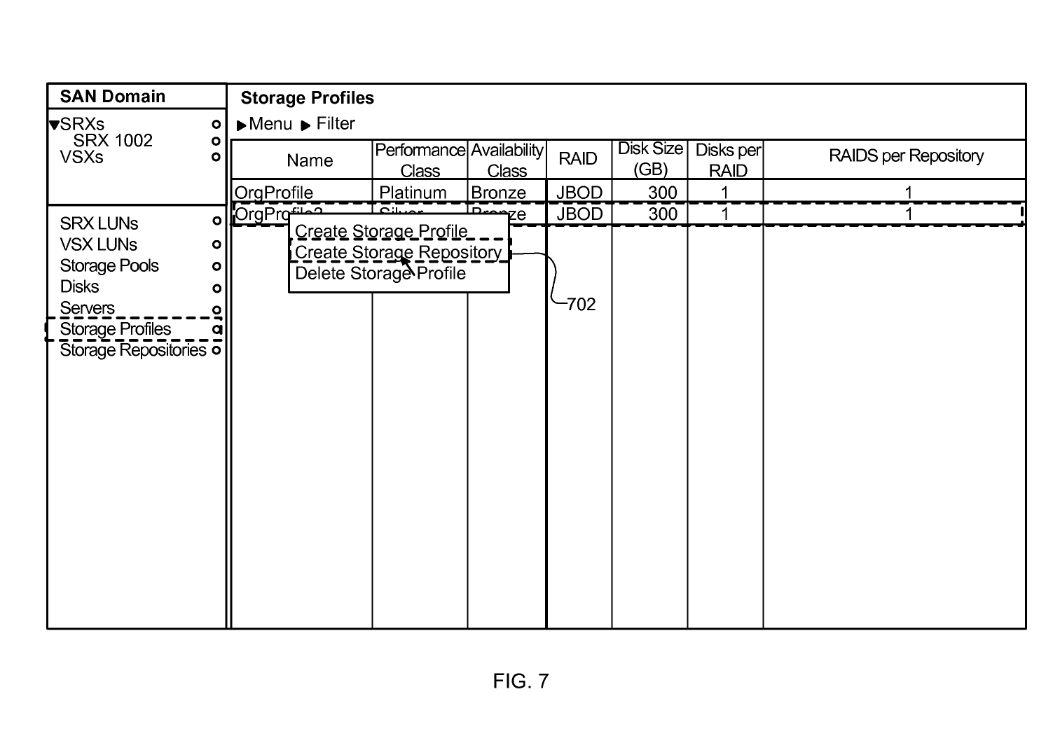

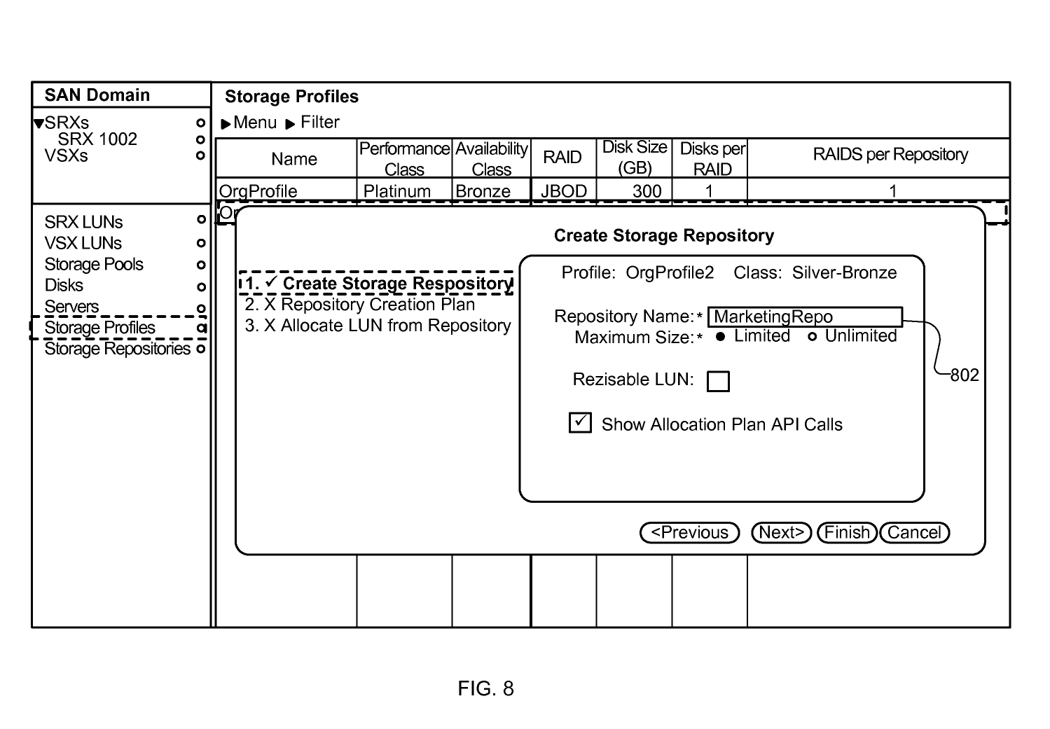

Referring to FIG. 7, illustrated is a user interface for starting generation of a repository creation plan, according to one embodiment. The user has selected 702 to use storage profile OrgProfile2 in creating a storage repository. The planning module 230 receives this selection of storage profile OrgProfile2. Referring to FIG. 8, illustrated is a user interface for generating a repository creation plan, according to one embodiment. After receiving a selected storage profile, the planning module 230 generates a user interface that allows the user to enter a name 802 for the storage repository. The user enters a name 802 for the storage repository, shown here as “MarketingRepo” which is received by the planning module 230.

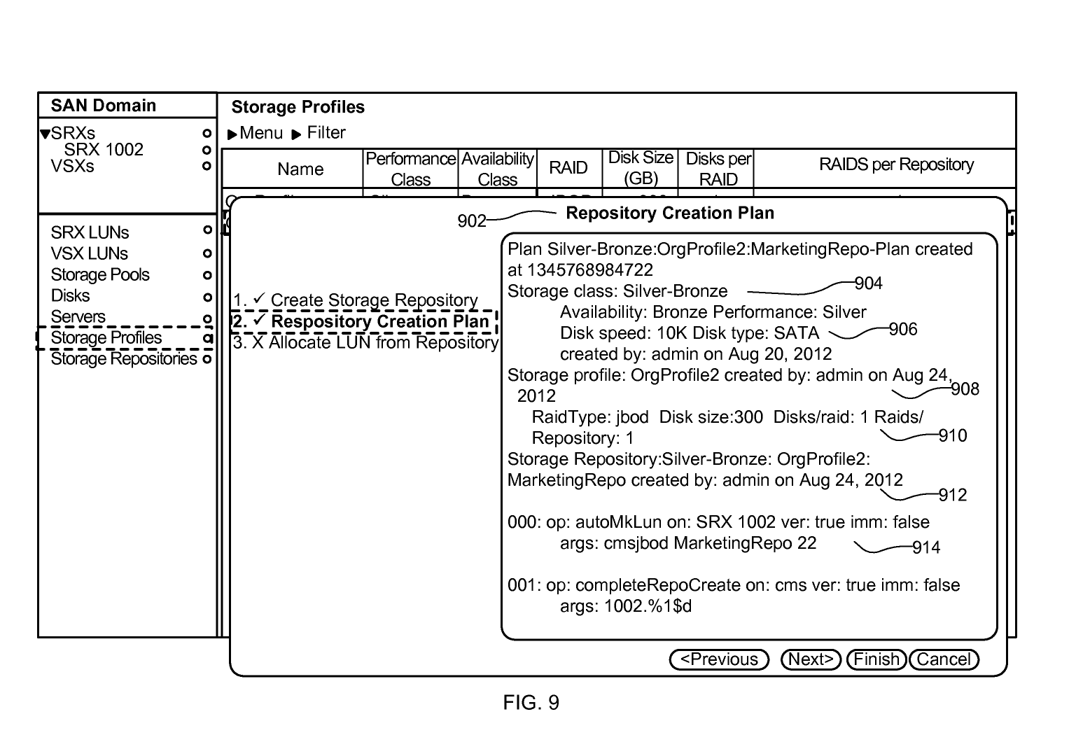

Referring to FIG. 9, illustrated is a user interface that includes a repository creation plan created by the planning module 230, according to one embodiment. The repository creation plan includes several details that are presented to the user for review and verification. For example, the repository creation plan includes the selected levels of storage service quality 904, the disk speed and type 906, the name of the storage profile 908, the RAID configuration 910 which includes the raid type and disk size, the name of the storage repository 913 and the specific storage component 914 that will be used for the storage repository.

Referring back to FIG. 2, the repository allocation module 235 receives user approval of a repository creation plan and applies the plan to allocate one or more storage components of the storage system into a storage repository, thereby creating a storage repository. The details of the plan exactly define the steps to be taken to create the repository. In one embodiment, the repository allocation module 235 allocates the storage components by transmitting information to the storage components in the storage system 160 that causes the storage components to be organized into the desired repository. In other embodiments, the repository allocation module 235 allocates the storage components by storing information in the management server 130 that links certain storage components to the desired repository. Repositories may have an initial size specified by the repository creation plan when first created, and more storage units can be added to the repository as required.

The LUN module 237 assigns LUNs to the storage repositories so that the application servers 150 can begin storing and reading data from the storage repositories. The LUN module 237 may assign one or more LUNs to each repository. For example, a 1 TB repository can be assigned a single LUN. Alternatively, a 1 TB repository may be sub-divided into smaller 10 GB portions, each of which is assigned a different LUN.

The storage communication module 240 handles communications between the other modules of the management module 140 and the storage system 160 in order to manage the storage components within the storage system 160. The storage communication module 240 can communicate with the storage system 160 to identify the storage capabilities of the storage system 240. The storage communication module 240 can also communicate with the storage system 240 to allocate repositories and assign LUNs within the storage system 160.

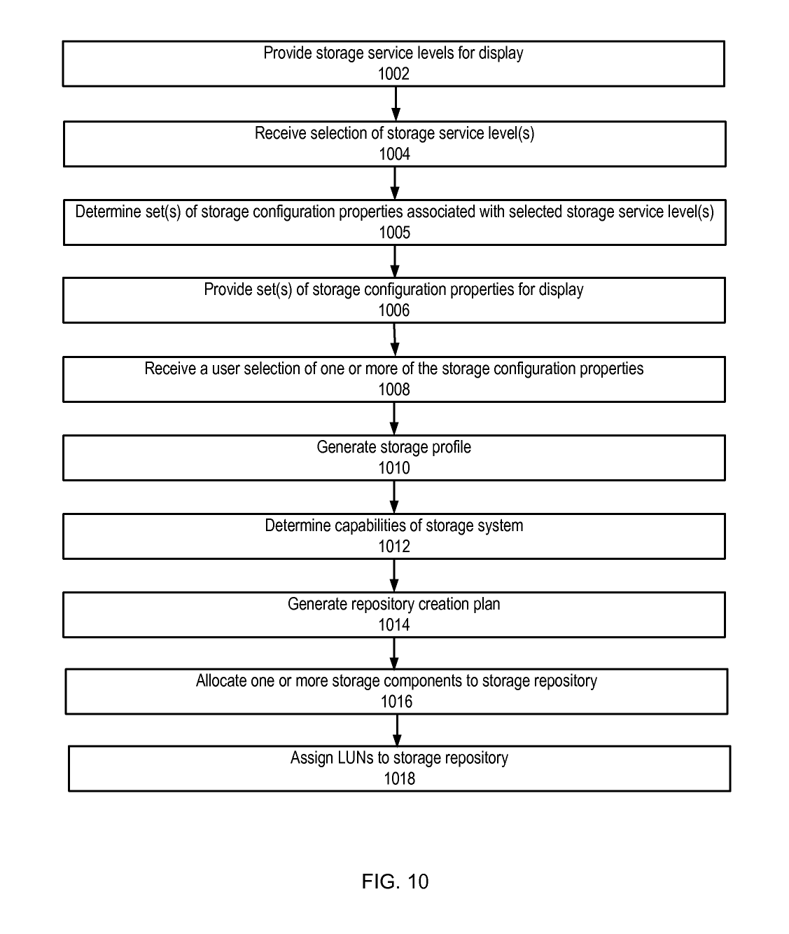

FIG. 10 is flowchart illustrating a process for storage management of a storage system performed by the management module 140, according to one embodiment. In step 1002, the management module 140 provides several storage service levels (storage classes) to the client 110 for display in a user interface at the client 110. Each of the storage service levels represents a corresponding target level of storage service quality for a storage repository that is to be allocated in the SAN, and each of the storage service levels is also associated with corresponding storage configuration properties. Additionally, the storage service levels may be presented for different dimensions of storage service quality, such as performance and availability.

In step 1004, the management module 140 receives a selection of one or more storage service levels from the storage service levels presented in the user interface. In other embodiments where the storage service levels are not presented for display, the management module 410 may receive the selection in the form of data from a program that indicates a particular level of target storage service quality for the storage repository. In step 1005, the management module determines set(s) of storage configuration properties that are associated with the selected storage service level(s). Each selected storage service level may be for a different dimension of storage service quality and be associated with its own pre-determined set of storage configuration properties. In step 1006, the management module 140 provides the sets of storage configuration properties associated with the selected storage service levels to the client 110 for display in a user interface at the client 110. In step 1008, the management module 140 receives a selection of one or more of the storage configuration properties presented in the user interface. The user selection can be, for example, a user selection of a subset of the storage configuration properties if there are multiple properties available to choose from. Alternatively, the user selection can be a user input approving the storage configuration properties that are presented to the user.

In step 1010, the management module 140 generates a storage profile based on the selected configuration properties and the storage profile is stored into the profile datastore 215. Once the storage profile is created, it can be used many times to create different repositories from the same storage profile. Thus, the following steps 1012, 1014, and 1016 can be repeated several times with the same storage profile. Similarly, step 1018 may be repeated on a repository many times without requiring the creation of a repository each time.

In step 1012, the management module 140 determines the current storage capabilities of the storage system 160. In step 1014, the management module 140 generates a repository creation plan based on the storage profile and capabilities of the storage system 160. For example, the management module 140 may compare the capabilities of the storage system 160 to the storage configuration properties of the storage profile and generate a repository creation plan only if the capabilities support the storage configuration properties. In step 1016, the management module 140 allocates one or more storage components specified by the repository creation plan to a storage repository, thereby creating a new storage repository. In step 1018, the management module 140 assigns one or more LUNs to the storage repository.

### Example Computer Architecture

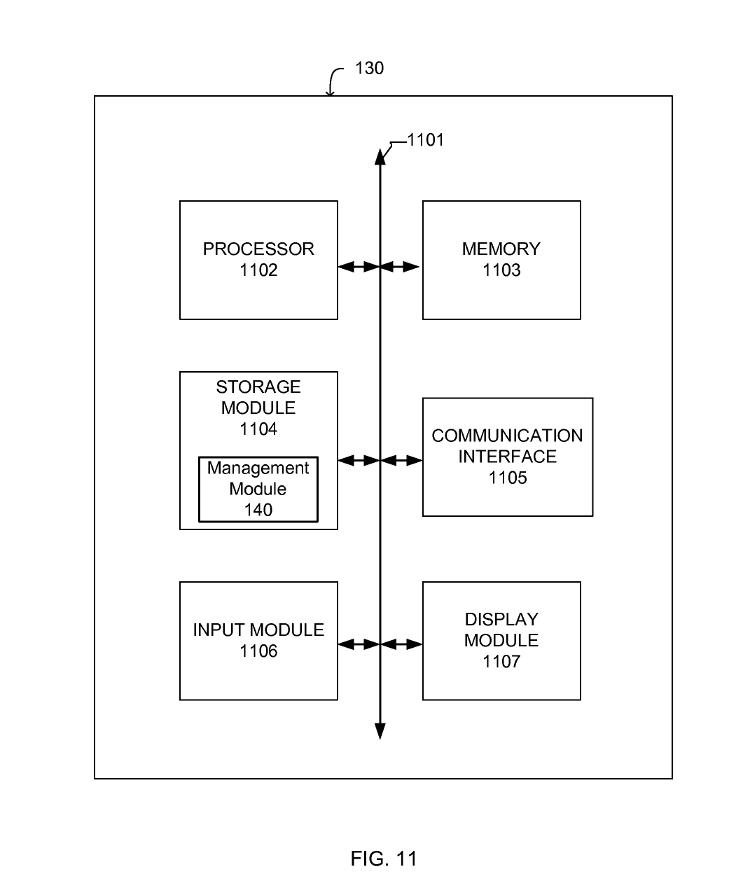

FIG. 11 illustrates the hardware architecture of a management server 130, according to one embodiment. In one embodiment, the management server 130 is a server computer including components such as a processor 1102, a memory 1103, a storage module 1104, an input module (e.g., keyboard, mouse, and the like) 1106, a display module 1107 and a communication interface 1105, exchanging data and control signals with one another through a bus 1101. The storage module 1104 is implemented as one or more computer readable storage media (e.g., hard disk drive), and stores software instructions that are executed by the processor 1102 in conjunction with the memory 1103 to implement the storage management described herein. For example, the storage module 1104 may include instructions in the form of a storage management module 140. Operating system software and other application software may also be stored in the storage module 1104 to run on the processor 1102.

As can be seen from the description above, the embodiments herein improve upon storage management of storage repositories in a storage system, such as a SAN. The user simply selects a target level of storage service quality for a storage repository, and the storage management module presents the user with storage configuration recommendations that satisfy the user's requirements to guide the user through the process of setting up the storage repository. Thus, even a user with little knowledge of the resources available in the storage system can manage the storage repositories with ease.

Upon reading this disclosure, those of skill in the art will appreciate still additional alternative designs for storage management in a storage system. Thus, while particular embodiments and applications of the present disclosure have been illustrated and described, it is to be understood that the embodiments are not limited to the precise construction and components disclosed herein and that various modifications, changes and variations which will be apparent to those skilled in the art may be made in the arrangement, operation and details of the method and apparatus of the present disclosure disclosed herein without departing from the spirit and scope of the disclosure as defined in the appended claims.

1. A computer-implemented method for storage management in a storage area network (SAN), comprising:
receiving a selection of a first target level of storage service quality for a storage repository to be created in the SAN, the first target level of desired storage service quality representing a level of storage service quality along a first dimension of storage service quality;
determining a first set of storage configuration properties associated with the first level of desired storage service quality; and
allocating one or more storage components of the SAN to the storage repository based on at least one storage configuration property in the first set of storage configuration properties.

2. The method of claim 1, wherein the first target level of storage service quality represents a level of performance of the storage repository.

3. The method of claim 1, wherein the first target level of desired storage service quality represents a level of availability of the storage repository.

4. The method of claim 1, wherein the first target level of desired storage service quality represents a level of affinity between logical unit number (LUNs) to be assigned to the storage repository.

5. The method of claim 1, further comprising:
receiving a selection of a second target level of storage service quality for the storage repository, the second target level of storage service quality representing a level of storage service quality along a second dimension of storage service quality that is different than the first dimension of storage service quality;
determining a second set of storage configuration properties associated with the second target level of storage service quality; and
wherein the one or more storage components of the SAN are allocated to the storage repository based on at least one storage configuration property from the first set of storage configuration properties and at least one storage configuration property from the second set of storage configuration properties.

6. The method of claim 1, further comprising:
outputting, for display, a plurality of levels of storage service quality for the storage repository, the plurality of levels of storage service quality representing levels of storage service quality along the first dimension of storage service quality,
wherein the first level of storage service quality is selected from the plurality of levels of storage service quality.

7. The method of claim 1, further comprising:
outputting the first set of storage configuration properties for display; and
receiving a selection of one or more storage configuration properties from the first set of storage configuration properties,
wherein the one or more storage components of the SAN are allocated to the storage repository based on the one or more storage configuration properties selected from the first set of storage configuration properties.

8. The method of claim 1, further comprising:
storing a storage profile into a profile datastore, the storage profile including a profile name in association with at least one storage configuration property from the first set of storage configuration properties,
wherein the one or more storage components of the SAN are allocated to the storage repository based on the storage profile.

9. The method of claim 1, further comprising:
determining storage capabilities of the SAN; and
determining whether at least one storage configuration property in the first set of storage configuration properties is supported by the SAN,
wherein the one or more storage components of the SAN are allocated to the repository responsive to determining that the at least one storage configuration property in the first set of storage configuration properties is supported by the SAN.

10. The method of claim 1, further comprising:
assigning a logical unit number (LUN) to at least a portion of the storage repository.

11. A non-transitory computer readable medium storing processor executable instructions for storage management in a storage area network (SAN), the instructions comprising instructions for:
receiving a selection of a first target level of storage service quality for a storage repository to be created in the SAN, the first target level of desired storage service quality representing a level of storage service quality along a first dimension of storage service quality;
determining a first set of storage configuration properties associated with the first level of desired storage service quality; and
allocating one or more storage components of the SAN to the storage repository based on at least one storage configuration property in the first set of storage configuration properties.

12. The computer readable medium of claim 11, wherein the first target level of storage service quality represents a level of performance of the storage repository.

13. The computer readable medium of claim 11, wherein the first target level of desired storage service quality represents a level of availability of the storage repository.

14. The computer readable medium of claim 11, wherein the first target level of desired storage service quality represents a level of affinity between logical unit number (LUNs) to be assigned to the storage repository.

15. The computer readable medium of claim 11, the instructions further comprising instructions for:
receiving a selection of a second target level of storage service quality for the storage repository, the second target level of storage service quality representing a level of storage service quality along a second dimension of storage service quality that is different than the first dimension of storage service quality;
determining a second set of storage configuration properties associated with the second target level of storage service quality; and
wherein the one or more storage components of the SAN are allocated to the storage repository based on at least one storage configuration property from the first set of storage configuration properties and at least one storage configuration property from the second set of storage configuration properties.

16. The computer readable medium of claim 11, the instructions further comprising instructions for:
outputting, for display, a plurality of levels of storage service quality for the storage repository, the plurality of levels of storage service quality representing levels of storage service quality along the first dimension of storage service quality,
wherein the first level of storage service quality is selected from the plurality of levels of storage service quality.

17. The computer readable medium of claim 11, the instructions further comprising instructions for:
outputting the first set of storage configuration properties for display; and
receiving a selection of one or more storage configuration properties from the first set of storage configuration properties,
wherein the one or more storage components of the SAN are allocated to the storage repository based on the one or more storage configuration properties selected from the first set of storage configuration properties.

18. The computer readable medium of claim 11, the instructions further comprising instructions for:
storing a storage profile into a profile datastore, the storage profile including a profile name in association with at least one storage configuration property from the first set of storage configuration properties,
wherein the one or more storage components of the SAN are allocated to the storage repository based on the storage profile.

19. The computer readable medium of claim 11, the instructions further comprising instructions for:
determining storage capabilities of the SAN; and
determining whether at least one storage configuration property in the first set of storage configuration properties is supported by the SAN,
wherein the one or more storage components of the SAN are allocated to the repository responsive to determining that the at least one storage configuration property in the first set of storage configuration properties is supported by the SAN.

20. The computer readable medium of claim 11, the instructions further comprising instructions for:
assigning a logical unit number (LUN) to at least a portion of the storage repository.
